(19) United States
(12) Patent Application Publication
(10) Pub. No.: US 2018/0047057 A1
(43) Pub. Date: Feb. 15, 2018

(54) DISTRIBUTED ADVERTISING SYSTEM AND METHOD OF USE

(71) Applicants: Walter G. MAYFIELD, Houston, TX (US); Richard A. WINLEY, III, Houston, TX (US)

(72) Inventors: Walter G. MAYFIELD, Houston, TX (US); Richard A. WINLEY, III, Houston, TX (US)

(21) Appl. No.: 15/516,321

(22) PCT Filed: Oct. 1, 2015
(86) PCT No.: PCT/US2015/053562

§ 371 Date: Mar. 31, 2017

Related U.S. Application Data
(60) Provisional application No. 62/159,049, filed on May 8, 2015.
(60) Provisional application No. 62/159,018, filed on May 8, 2015.
(60) Provisional application No. 62/137,010, filed on Mar. 23, 2015.
(60) Provisional application No. 62/137,001, filed on Mar. 23, 2015.
(60) Provisional application No. 62/133,078, filed on Mar. 13, 2015.
(60) Provisional application No. 62/133,070, filed on Mar. 13, 2015.
(60) Provisional application No. 62/104,424, filed on Jan. 16, 2015.
(60) Provisional application No. 62/104,299, filed on Jan. 16, 2015.
(60) Provisional application No. 62/063,079, filed on Oct. 13, 2014.
(60) Provisional application No. 62/058,493, filed on Oct. 1, 2014.

(51) Int. Cl. G06Q 30/02; G09F 21/02; G09F 21/04

(52) U.S. Cl. CPC G06Q 30/0267; G06Q 30/0261; G06Q 30/0266; G09F 21/04; G09F 21/026

(57) ABSTRACT

Distributed advertising can be accomplished employing systems that include a portable display device, and a controller, wherein the display device can determine its geographic location. Such a system can then communicate its location to a controller which in turn can then download to the display device advertising content. People transporting the display devices, either by foot or by vehicle, can be compensated for their efforts.

### TECHNICAL FIELD

The present invention relates to a system useful for distributed advertising. The present invention particularly relates to such a system wherein the advertising content is imparted using a mobile display.

### BACKGROUND

Currently, Internet usage, and particularly that of the World Wide Web (henceforth referred to as simply the “web”), is growing explosively, particularly as the number of web sites and users that have access to the Internet continue to rapidly, perhaps even exponentially, expand. Such advertising, though no doubt valuable, is not without its drawbacks.

For example, “click” advertising, while useful, necessarily requires that a great number of potential consumers see advertisements before there is a conjunction between the advertisement and a consumer who needs the services. Stated another way, this kind of advertising requires the casting of a great number of advertisements to the winds in the hopes of an interested buyer receiving.

It would be desirable in the art of advertising to be able to selectively advertise goods and services in limited geographic areas while generating a comparatively large number interested buyer/advertisement interactions.

### SUMMARY

In one aspect, the invention is a system for distributed advertising comprising: a portable display device, and a controller, wherein: the display device is in communication with the controller, the display device is portable, the display device, or an associated device is able to receive and interpret a GPS signal or other signal which can be used to ascertain the location of the display device, and the display device, or associated device, is configured to display advertising upon command from the controller.

In another aspect, the invention is a method of distributed advertising comprising: wirelessly establishing communication between a portable display device and a controller wherein: the display device or an associated device senses its location and uploads that information to the controller; and the controller, based upon the location of the display device, transmits to the display device advertising content.

### BRIEF DESCRIPTION OF THE DRAWINGS

The advantages and further aspects of the disclosure will be readily appreciated by those of ordinary skill in the art as the same becomes better understood by reference to the following detailed description when considered in conjunction with the accompanying drawing(s) wherein:

FIG. 1 is an illustration of a hypothetical bid offering; FIG. 2 is an illustration of the use of multiple transporters for a spatial advertisement;

FIG. 3 is an illustration of a 2^{nd} hypothetical bid offering;

FIG. 4 is a first example of a display device in use in a vehicle;

FIG. 5 is a side view of the display device of FIG. 4;

FIG. 6 is a collage of display devices configured to be worn and the cases useful for wearing them;

FIG. 7 is an illustration of using a backpack to wear a display device; and

FIG. 8 is a second example of a display device in use in a vehicle.

FIG. 9 is an illustration of capturing audio or video from a fixed display.

### DETAILED DESCRIPTION

In one embodiment, the invention is a system for distributed advertising comprising: a portable display device, and a controller, wherein: the display device is in communication with the controller, the display device is portable, the display device, or an associated device is able to receive and interpret a GPS signal or other signal which can be used to ascertain the location of the display device, and the display device, or associated device, is configured to display advertising upon command from the controller.

For the purposes of this invention, the term “distributed advertising” means advertising which is made available to the public using portable displays wherein the material advertised is selected on the basis of the location of the display device.

In the system of the application, the “display device” may be an iPad or other tablet computer, other computer of other types, and any other device having a display of any size. In another embodiment, the display device may be a cell phone. In still another embodiment, the display device may be a monitor being controlled by a computer or a smart phone. In one embodiment that would be especially useful with vehicles, the display device would be a projector which projects advertising content upon the rear window of a vehicle. Another similar embodiment bid be one where the display device is a tablet computer configured to hang from the back of a headrest; which could be very useful in a taxi or other vehicle carrying passengers.

For purposes of the present application, the term controller means a server on the web, a standalone computer which may or may not be connected to the web; but is equipped to communicate wirelessly using Wi-Fi, Bluetooth, and the like.

The display devices used for advertising are portable. This means they can be either transported by a vehicle or by a pedestrian. For the purposes application, the term vehicle means automobile, truck, bicycle, motorcycle, Segway, and any other vehicle except airplanes and lighter than air aircraft. Regarding the exclusion to the use of aircraft, this exclusion does not apply to display devices with in an airplane, only those on the outside of the aircraft.

In the system of the application, the display device maybe configured to be wirelessly connected to the server. Ways in which this can be achieved include but are not limited to, a mobile data system such as those used with cell phones, Wi-Fi, Bluetooth, and the like.

Where a display device requires an associated device to be wirelessly connected to the controller, the combination of these 2 devices shall be treated as a single device hereinafter in this application.

The display device may include a GPS receiver, or other component which allows the display device to ascertain its current location with sufficient accuracy in regards to geography to be useful in real time advertising. Also, the GPS receiver or other component must allow this to occur quickly enough to be useful in real time advertising. For the purposes of this application, the term “real-time” means that the communication occurs quickly enough that the display device is still within relevant proximity for downloaded advertising information or data to be displayed within the area specified by the advertiser.

The controller is employed within the systems of the application are configured to download advertising information or data to display devices.

The display devices (possibly in combination with associated devices) may further include a compass, motion detector, camera, sensors to determine the orientation of the display device, and any other component which would facilitate advertising. Such components include those which would facilitate determinations of the number of pedestrians or drivers viewing the advertising information or data.

In one embodiment, the display device may be configured to operate with other display devices. For example, in one embodiment, the display device may actually be 3 display devices, strung together via software, to display a single message or allow a message which is shorter than one or 2 display devices to be displayed as moving across all three.

In the practice of the method of the application, the display device transmits to the controller its location. In one embodiment, the controller then can download advertising information or data (such as but not limited to photographs, drawings, and graphs) selected to be relevant to a vendor or service provider in near geographic proximity. For the purposes of this application, the term “advertiser” means a vendor or service provider who is a subscriber to use a system of the application for advertising purposes.

Advertisers may select the size of the geographic area in which their advertisements will be displayed. That size will be a function of the type of advertiser, or rather the goods or services provided by the advertiser, and these speed and velocity of the display device.

In one embodiment, the display device may be attached to a backpack, or harness and carried by a pedestrian. This will also work with a person on a bicycle or motorcycle or other unenclosed vehicle. In one desirable embodiment, a tablet computer is attached to the back of a backpack while being carried through a mall.

In another embodiment, the display device may be attached to the back window of a automobile, particularly one that has a flat rear window. In still another embodiment the display device used in that application can be a monitor used in conjunction with an associated device such as a cell phone or a tablet computer.

In yet another embodiment, the display device may be displayed on the outside of the vehicle while contained in a case to both hold it securely in place and prevent damage or defacement by water, dirt, and tossed up debris.

In the practice of the methods of the application, the display device will upload its location to a controller. In one embodiment, this is done sufficiently often that an accurate determination of the velocity of the display device is recorded, preferably on the server. In another embodiment, the display device itself will make a determination of its velocity. This philosophy along with other data may be used to determine the number of pedestrians are drivers viewing the displayed advertising content.

One such device which could be used to assist in this determination would be a camera. Another such device would be a motion detector. While not a device, where the display device is being transported across a motorway, traffic reporting services could also be used to estimate the number of viewers for the advertising content.

One aspect of the method of the application is that the system of the application would be employed to reward transporters for effecting advertisements. For the purpose of this application, a transporter is one who directly, or through a subcontractor, transports a display device either by foot or by vehicle. In one embodiment of the method of the application, the transporters would be paid based on the number of viewers of the advertising content.

In addition to being used to reward the transporters, the system of the application can be used to provide reports to advertisers. For example, in one embodiment, a report could be generated for the advertiser which would disclose the number of advertisements made within a specified area, the number of viewers of the advertised content, and the dates and times that those viewings occurred.

In one desirable embodiment of the method of the application, velocity, geographic location, and the distance from the display device to the nearest and furtherest viewers can be used to select both the advertising content and its size on the display device. For example, where viewers are further away, or the velocity differential between the display device and the viewer is high, then necessarily the advertising content will need to be comparatively large. An exemplary situation would be where a motorcyclist or bicyclist is being quickly passed by other vehicular traffic.

In contrast, another desirable embodiment of the method of the application would be a situation where a pedestrian wearing a backpack having a tablet computer as a display device is walking in a mall. The velocity differential would be that of the difference between the velocity of the viewers and the velocity of the transporter. In this situation, with a comparatively small velocity differential, the size of the advertising content could be comparatively small since an observer would have more time to peruse the advertising content.

In some embodiments, the controller could be employed to make changes to the settings of the display device. For example, where the display device is being employed the controller can adjust the brightness of the display device to be effective relative to the ambient light conditions. In still another embodiment, a microphone in the display device could be employed to determine the level of ambient noise and then adjust the speaker volume of the display device for advertisements that have an audio component.

In an alternative embodiment, the controller may be a device located within a specific store within a mall, somewhat analogous to an iBeacon, wherein the device within the store transmits to the display device the advertising content in the proximity in which it is to be displayed. For example, a vendor within a mall could connect to a system of the application and specify advertisements to be shown within 50 feet of his storefront.

The display devices used with the system of the application desirably will include a compass and other components that will allow for their use during periods of no service. For example, if a transporter were to board a subway, their efforts at advertising and the duration of the advertising would be recorded and uploaded back to the controller upon the reestablishment of contact. In at least one embodiment, a second controller could be used for these purposes.

The display devices employed with the methods of the application will include components that allow for the verification and quantification of the transporters' advertising efforts. For example, a camera, and a sensor which detects the orientation of the display device can be employed to verify that the device is actually being displayed to viewers. If a transporter has the display device waiting horizontal to the ground, they would not be paid for their efforts. Similarly, if a camera in the display device is accessed and does not show any viewers, in at least some embodiments, the transporter would not be paid.

In situations where a transporter desires to restrict the type of advertising that he is willing to have displayed on his display device, advertisements can be grouped by type. For example, advertising could be grouped by: “green” advertising; adult advertising; non-vegetarian advertising; and the like. Once a menu of advertisers or types of advertising is generated, transporters would be allowed to select or exclude advertisements or advertisers from the menu.

In another embodiment of the application, transporters can be solicited using the Internet. Once a transporter or rather a would be transporter decides to become a transporter, then they could upload an “AP” to make their display devices a part of a system of the application. The “APs” may be distributed using extant distribution centers, such as the Play Store and The App Store. In an alternative embodiment, a dedicated website can be used to distribute software to would be transporters.

The distributed advertising systems of the application may be employed in such a way that transporters are paid for their efforts. One advantage of the systems of the application is that they may be selected based on their proximity to a specific vendor or other location. In one embodiment, the systems of the application are employed using a business plan where advertiser offers to pay transporters varying rates. For example, in one such embodiment, an advertiser may elect to offer a rate of $5 to transporters within 1 km of their establishment; $3 to transporters within 5 km but outside of 1 km; and a standard rate of $1 for transporters more than 5 km from their establishment.

In an alternative embodiment, rather than the advertising rate being based upon its proximity to a retail establishment, the rates may be rather tied to their proximity to an event. For example, all transporters attending a festival/event may be deemed by certain advertisers to be especially valuable and alternative rates offered for that general location during the period of the festival. Still, just as in conventional advertising, the rates may be based upon the size, type, and location of the display device.

One issue advertisers may face is the possibility that there may be too many transporters in a given area. If they would advertise on all the transporters they may actually over saturate the area of advertising. In some instances, this has been known to have a negative effect upon consumers! There are several solutions to this issue.

One such solution would be to allow a fixed number of transporters to display the advertisements on a first-come first-served basis. In an alternative embodiment of the solution, the advertisers may put it up for bids. In this embodiment, the advertisers would make “jobs” available to transporters, offering the work at a escalating rate with the jobs accepted by the transporters by bidding until all available positions are taken.

In situations where there is an excess of display devices in a given geographical area or where display devices are only partially utilized via conventional advertising, the system of the application may be employed to allow the display device owners to fill the gaps and fully utilized their assets.

In situations where there is an excess of display devices in a given geographical area or where display devices are only partially utilized via conventional advertising, the system of the application may be employed to allow the display device owners to fill the gaps and fully utilized their assets.

In still another embodiment, the advertisers may be able to select from a group of “elite” transporters. The status of a transporter could be determined based upon their general availability, effectiveness based upon how many people (pedestrians and/or drivers) see their advertising content wherein that determination is made using a camera or other proximity sensing device.

In one very unique embodiment of the method of the application, advertising content can be distributed to multiple transporters such that a part of the advertisement is sent to each transporter. This is somewhat analogous to the old Burma-Shave signs. In the mid-20^{th} century, a manufacturer of shaving cream, would put a series of signs along the highway at a fixed interval. Each sign would require the driver to see the next sign and the next sign in order to get the full content of the message. In one embodiment of this method of the application, a 10 word advertisement could be displayed on 10 individual transporters' devices. In yet another alternative embodiment, the same 10 transporters could spell out a single 10 letter advertisement. This would be particularly effective at events where stadium seating would be available so that the words and/or letters could also be arranged spatially to add emphasis to the message.

In embodiments of the methods of the application where the display devices are capable of accepting input, then advertisements may be displayed that would allow input by people observing them. One such advertisement would be a survey. Exemplary of such an advertisement would be a survey for the observer's preference for a political party, a commercial product, or the like. In practice, the advertisement we displayed on the display device and input would be invited using an input device. Where the display device is a tablet computer, then a person observing the advertisement could touch on a radio button, or other input on a touch screen.

A more specialized display device could be used where the specialized display device would be configured to interface with one or more input devices such as a game controller or a keypad are you a joystick. This would be particularly useful where a longer survey was involved. An exemplary method were such a device could be employed would be one where a transporter displayed an invitation to people observing to take part in a survey, once an observer indicated interest, they would be allowed and input device, and using the input device in her data into the survey directly on the display device.

In addition to surveys, similar methods could be employed where people observing the advertisements could provide contact information to receive coupons or other incentives. These could be in the form of coupon codes that can be offered to a retailer for discount on food, goods, and/or services. In an alternative embodiment this could be in the form of actual coupons carried by the transporter or made available by use of an automatic dispenser. In still another embodiment, the coupons could be made available by displaying on the display device a link for an observer to activate to get access to digital or printable coupons. Of course, a display coupon can always be photographed by an observer in the photograph used to redeem the coupon for goods or services at the subject retailers, including e-retailers. As another example, a coupon including a QR code could be displayed.

Another embodiment of the method of the application is pro bono advertising. For example a transporter could be incentivized to become a transporter if he were able to promote issues or products that were of interest to him during periods where he was not being actively paid by an advertiser.

In yet another method of the application, transporters can be incentivized to become transporters by offering equipment at low or even no cost conditioned upon the transporter participating in the program. For example, in one such embodiment, a display device can be provided to a transporter at no cost upfront with the condition precedent that they participate in the program and a percentage of their remuneration be redirected back to the provider of the display device. In an alternative embodiment, the display device could be rented (perhaps with an option to purchase) to a would-be transporter.

In one particularly desirable embodiment, the advertisers using a system and our method of the application could be the customer service department of a vendor. For example, if a consumer of a vendor's products needed customer service and if that consumer had no ready access to a tablet computer or the like, and if that vendor were a participant as an advertiser in a method of the application, then it would be possible that the vendor could locate a transporter near the consumer and redirect the transporter to the consumer and make use of the display device to provide customer service. For example, if a automobile manufacturer were a advertiser and if one of their car owners were to have a problem with their automobile, the automobile manufacturer could redirect a transporter to assist the driver.

This would be facilitated because of the fact that most of the display devices are likely able to run third-party software. A transporter having a device that could run FACETIME (a trade designation of Apple Inc.) could be directed to a consumer by a vendor who was also an advertiser in the FACETIME program employed to deliver the customer service.

For the purposes of this application the term “advertisement” and “advertising information” is expanded to also mean information or intelligence collected by a transporter. Methods of the application would have embodiments where an advertiser could be an agency such as a television station which has a news reporting function. If there were a developing situation, the television station advertiser could redirect a transporter to a “developing story” and get intelligence utilizing the display device, particularly the camera and microphone. In the alternative, transporters and especially elite transporters could be tasked with moderating an event such as morning traffic or weather developments. In still other embodiments a business or individual may pay transporters in an area of interest to take pictures or video of real estates, events, and the like.

The term “advertisers” is further expanded for the purposes of this application to include providers of services employing transporters to deliver the services. Exemplary of such advertisers would be companies providing interpreters. One embodiment can be illustrated by a situation where a traveler in a foreign country who does not speak the language finds himself in a difficult situation is delivered a translation service via the display device. Because the display devices useful with the systems of the application have display screens services that can only be provided in a visual format could still be delivered using the display devices. Exemplary of this embodiment would be a situation where communication with someone that speaks only sign language could be remedied by taking advantage of a nearby transporter who could make use of a sign language interpreter. Obviously, in this embodiment, the sign language we would be displayed on the display screen with the translator taking advantage of the microphone on the display device to hear what was being said; and taking advantage of the cameras on the display device to see what signs needed interpreting.

The systems of the application can desirably include components which will facilitate evaluating transporters. As already discussed, most display devices contemplated will have a camera, speaker, microphone, and a GPS receiver. Also, in some embodiments, it would be useful if the display devices were to include Bluetooth transceivers, Wi-Fi transceivers, and spatial sensors. All of this equipment can be employed to ensure that the transporters are living up to their obligations to the advertisers. For example, where the display device is a smart phone, it can be employed to count the actual steps taken by a transporter. This would both prevent fraud and allow the “elite” transporters to be recognized.

The systems of the application can be employed for positive social purposes. Exemplary of this would be situations where pro bono advertisements were placed for museums, charities, and the like. Similarly, the systems of the application could be made accessible to civil authorities for important announcements such as tornado warnings, Amber alerts, and shelter in place announcements.

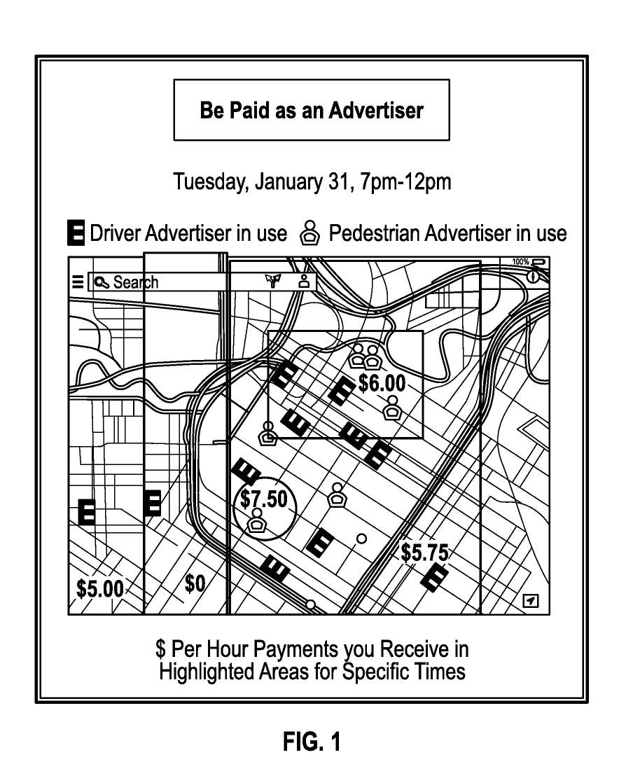

Turning to the drawings, FIG. 1 is a hypothetical bid offering. Therein a bid offering showing 5 separate rates for transporters who are in a selected geographic area. Transporters would be paid at the rates shown. For example a transporter could be paid a high of $7.50 to a low of no payment at all depending on which part of the selected area they were at. Note also that different rates are offered for pedestrians and transporters who are in a vehicle.

FIG. 2 is an illustration of the use of multiple transporters for a spatial advertisement. In this illustration, 8 transporters each display one letter of a “GWEE NOW!” advertisement. Such an advertisement would be especially effective in a setting that has stadium seating such as a sports stadium, a gymnasium, or the like.

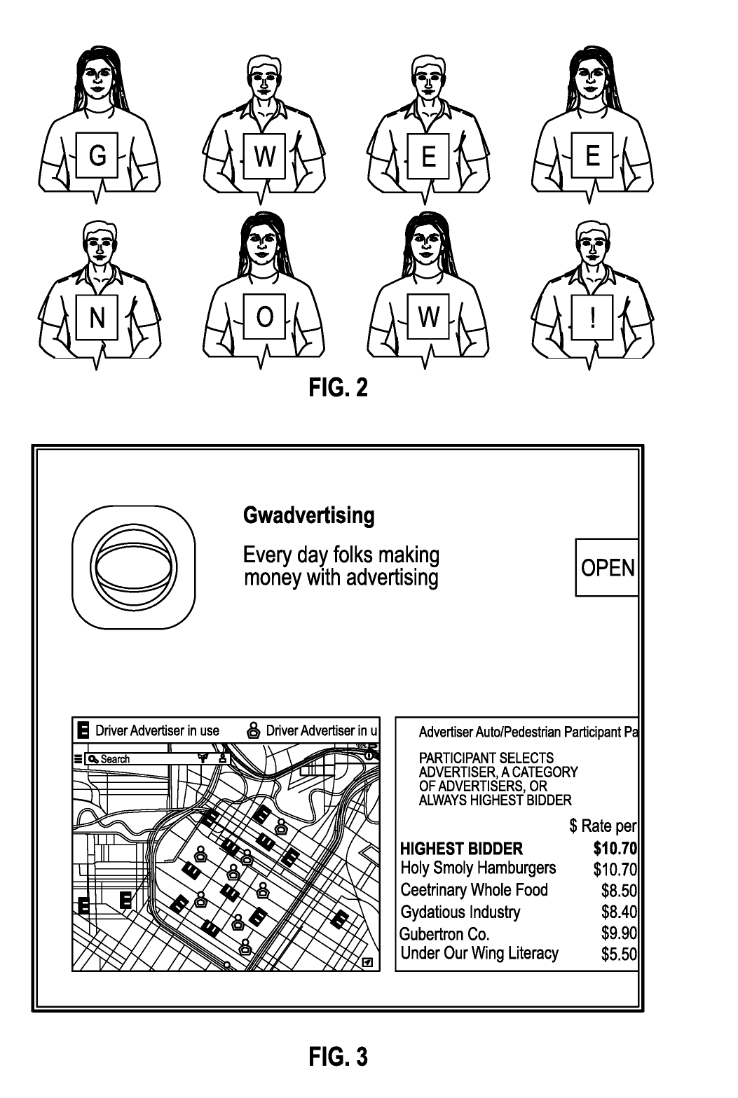

FIG. 3 is a hypothetical bid offer from multiple advertisers. In one embodiment of the method of the application, it may be that there may be more advertisers or at least advertising demand in a given geographical area then there are transporters to provide such services. In such an event it may be possible that the advertisers will bid for the services of the transporters. In the figure, on the left side there is an illustration of a map with an area selected as being of interest. On the right is a listing of advertisers looking for transporters to display their advertisements. In this instance, there were 5 advertisers offering from a low of $5.59 to a high of $10.76 for a transporter. In some embodiments, the transporter will be able to have the server and are his display device automatically select the highest bid. In other embodiments, the transporter may elect to choose a lower paying advertisers based upon his or her concern regarding the subject matter of the advertisement.

Finally, the portable display devices such as tablets, iPads, and iPhones useful with the portable advertising systems of the application may be used to take electronic payments for sale and delivery of product, services, or nonprofit causes. For example, Apple Pay™, a mobile device swipe card reader, or other electronic device, directly or wirelessly connected to the portable advertising system may be used to transact a sale. The portable display advertising systems may incorporate an manual input device to allow a purchaser to input credit card and delivery information. In another embodiment, the credit card and or delivery information could be inputted using an application running on a cellular phone or other portable device.

Any method and/or device useful for conducting a remote or automatic sale known to those of ordinary skill in the art may be employed with the portable display advertising systems of the application. In such an embodiment, the portable display advertising system itself, or the transporter manually, may email or even text an entity selling goods and/or services, such as Amazon™, the information necessary to complete a transaction. In the alternative, the portable display advertising system may communicate to a purchaser a seller's specific item information or even the seller's general website, and then allow the purchaser a chance to complete the purchase on their own. In still another embodiment, this information may be retained by the system for future reference and/or distribution. Such embodiments would allow any portable display advertising system of the application to connect with any seller in the world to advertise a product in most any location at any time and conduct an immediate sale.

Taking this concept even further, advertising may be made even more personalized towards a particular “customer”. For example, if a customer frequents certain locations then customize advertisement for those locations can be displayed. In the case of a clothing store, advertisements relating to that particular store or even a competitor could be displayed. A customer being chauffeured by taxi or limousine or even a bus could be shown advertisements relating to his destination. For example where that destination is an airport then airport services and amenities could be advertised.

Going yet another step farther, information gathered on any particular client could be retained for future use. Exemplary of this would be a situation where the fact that a client gambles at a particular casino or purchases certain luxury or upscale merchandise; that situation could be the basis for generating advertisement for completely different goods that are often bought by people purchasing items at that particular customer has historically purchased.

In one preferred embodiment, the portable display device is a tablet or other display used within a private taxi such as those contracting through Uber. Information which may be taken includes but is not limited to the route chosen by the traveler and the fee they pay; name and other personal or customized information regarding the driver; and the like.

This information may be collected by taking advantage of the Wi-Fi, Bluetooth, or other connection associated with devices that the traveler may be carrying. Exemplary of this would be technology associated with Near Field Communications (NFC) which may include cloud communication and proximity card technology.

An example of such an embodiment would be one where the passenger/traveler is shown advertisements relating to tour guides, restaurants, and other local attractions.

Another example of such an embodiment would be employing a camera, typically one incorporated into the display device, to provide security for the traveler. Another example would be where the traveler is able to interact with the display device and change their destination or the route being taken or even just surf the Internet. The display device could even be used to request a pickup time for a future trip.

In another embodiment, the display device could be employed to allow the traveler to be an advertiser. In a similar embodiment, the driver could be the advertiser. In either case, they could advertise goods, and even employ the vehicle to deliver the goods to the customers. They could also use the device to accept payments.

Especially in situations where the display device is acting as a hotspot, the traveler could download a special “app” which would then interact with the drivers display device.

Once the information is collected it could then be employed to create target commercials for the specific customer to be displayed upon their personal electronic devices, home television, desktop computers, fixed display devices such as digital boards and signage along streets inside buildings such as an airport. The fixed and mobile signage may recognize the customer based upon the interconnect ability of their device, whether it be a cell phone or a tablet or what have you, and then employed the previous collected information for the targeted advertisements.

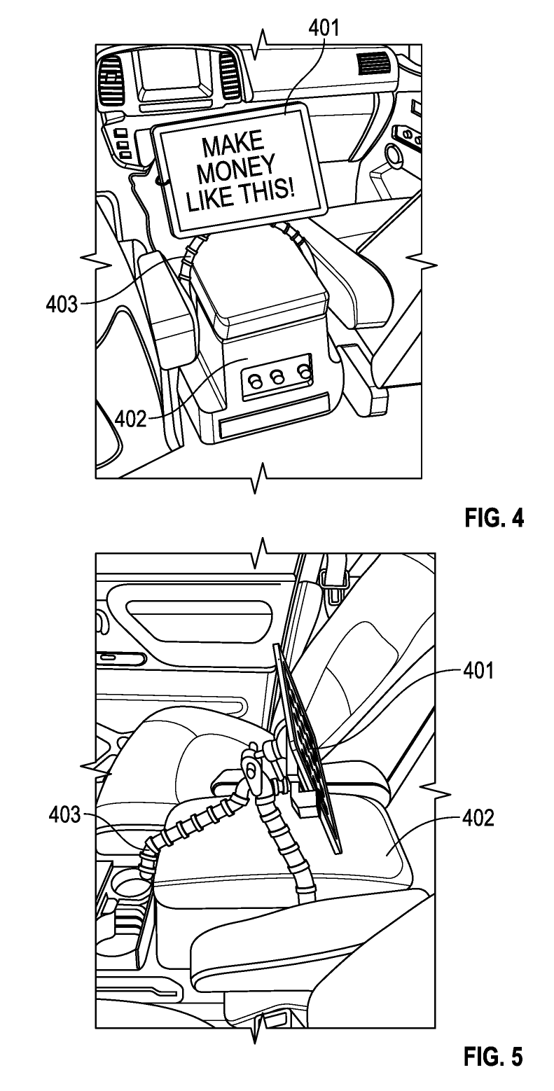

When a driver is using a display device, it may be employed in any way known to be useful to those of ordinary skill in the art mount the display device so that it can be visible to a traveler/passenger. Turning to FIG. 4, a display device (401) is shown configured to attach to a center console of a car (402). FIG. 5 is a side view of that same device installation. In this embodiment, the bendable legs (403) of the holder have sufficient tension to hold the device in place. Other configurations could employ adhesive straps (themselves employing a tacky adhesive) or hook and eye connections such as are employed with the use of Velcro.

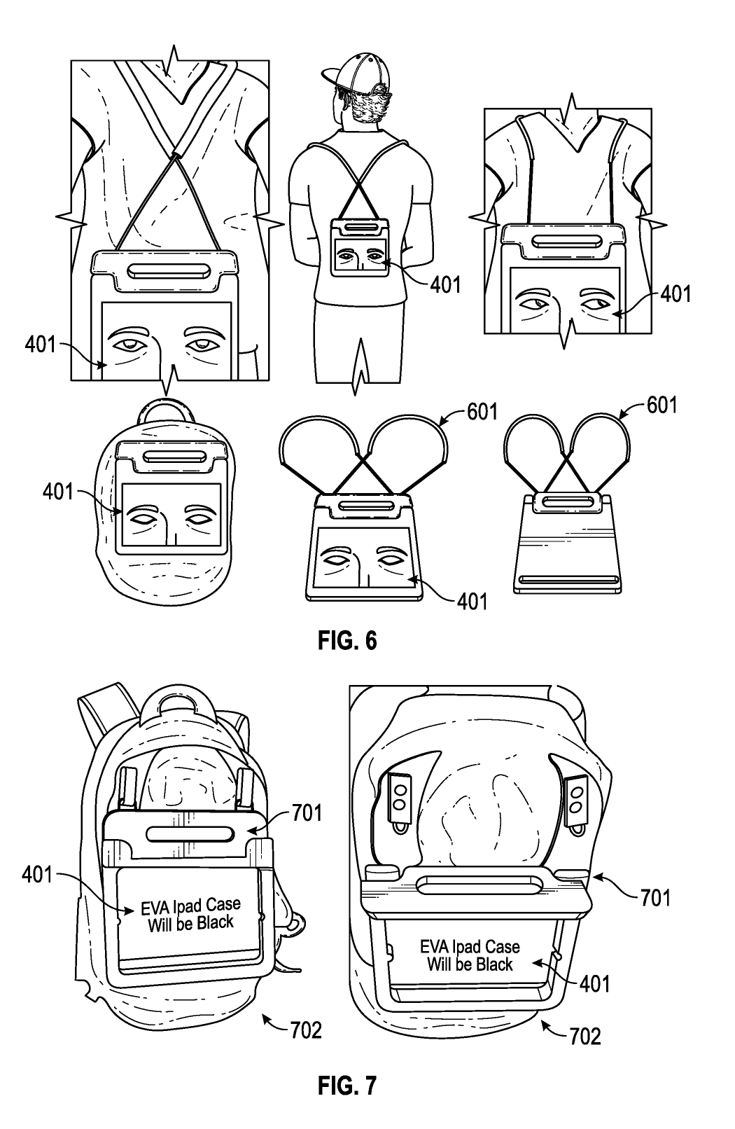

For purposes of completeness, in one embodiment the invention is a method of advertising comprising advertisers employing wearable display devices. In FIG. 6, several different embodiments are shown where a display device can be worn attached to the front or the back of the advertiser. As is illustrated here, the display device is held in place using straps (601).

In an alternative embodiment, FIG. 7 shows a backpack (701) configured to receive a display device (401). The display device can be affixed to the backpack using any method of doing so known to those of ordinary skill in the art, including but not limited to hook and eye (Velcro(TM), tacky adhesives, and the like. In one embodiment the display device would be affixed to the back employing hook and eye connectors on straps with the straps being looped around the backpack shoulder straps.

The advertiser would then carry display device around using the backpack. In instances where the advertiser is also caring around merchandise to be sold, and if the merchandise itself is small, then the advertiser/merchant could complete a sale, having advertise the goods; found a buyer; accepted payment; and then delivered the goods. All this can be performed using the systems and methods of the application.

The method and systems of the application can include software which can be downloaded for use on a portable device. This software can be used to interact with advertising devices for additional functionality. Exemplary of this would be an instance where advertisement for a restaurant or by a service such as OPEN TABLET™ was on display and a user could interact with the display device to make a reservation. Also, the software could be used to collect data from the downloader and then utilized by the display device to tailor advertising or the delivery of other content.

Such an embodiment would be particularly useful with an application employing a mobile display device. Where the display device was in a conveyance for hire, the software would allow for leaving a comment regarding quality or possible booking another conveyance for a return trip. Synergism occurs where the advertisement being displayed is for a nearby store which then would allow the person viewing the advertisement to take advantage of a sale or other offer.

Another advantage of the portable devices is that, in some embodiments, they may be used for providing security or surveillance. For example, if a display device is employed in a conveyance, it can be employed to take photos or videos of passengers which could be useful if a crime were committed upon the conveyance.

Even if the use has not downloaded the subject software, other programs, such as Facetime™ for example, may be used for concierge care such as directions, assistance with purchases, airline travel, translations, a politician interacting with the public, private citizens engaging in advocacy, or most any type of help from a live person.

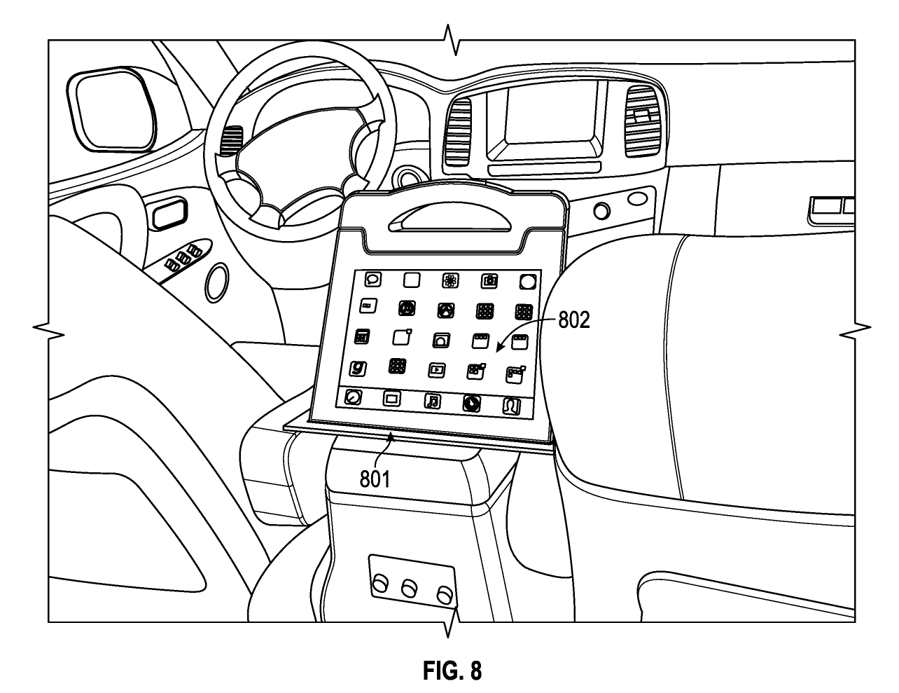

Turning to FIG. 8, a device for using a portable display in a vehicle is shown. This embodiment shows an stand (801) configured to receive an i-Pad tablet device (802) that can be removed by a passenger and place in the passenger's lap for viewing. The stand secures the display device to accommodate acceleration and bumps. Optionally, the display device may be tethered to the stand to prevent or at least reduce theft. This device can be further enhanced by the addition of a charging port (not shown) that is configured to connect to the electrical system of an automobile or other source of power. Another enhancement could be the inclusion of speakers that are configured to connect to the display device.

The stand itself is a removable center console stand that may be employ, for example, a bean bag type or cushion type element that is secured to top of center console by straps, Velcro™ or other hook and eye fasteners, sticky material, or magnets configured to display an electronic device to back seat passengers. The stand secures the electronic device from auto accelerations but enables a passenger to easily remove electronic display device from stand for personal use. In one embodiment, the straps may be wrapped around the center console lid to further secure the display device.

In another embodiment of the application, an electronic display may either link with neighboring displays or with hardware at retail stores to transmit appropriate data or advertisement based on proximity. In the alternative, a display device may employ latitude and longitude information to sync with a central computer that has real time inventories of advertisements in either digital or non digital form and transmit that information or related information to, for example, the same or a different electronic display device in a car or on a pedestrian.

Exemplary of such an embodiment, an auto for hire is driving past a billboard which is either digital or non digital. The billboard appears on the electronic display device or either before, during, or after passing the billboard. The same can be true for a retail store such as Starbucks™ appearing on the Electronic display device when the electronic display is proximal to the vendor. In an alternative embodiment the contents of the display of a system of the application can be displayed on a digital billboard.

In another embodiment, an electronic display in auto for hire such as Uber® may be used by a customer for travel destination assistance. Customer may use programs such as Waze to find shortest and fastest routs to ensure driver is being efficient. Additionally, electronic display may interact with a driver for hire program such as UBER to provide travel choices and integrate advertisement. Finally, as mentioned above, the systems of the application could be employed to add additional functionality by providing security images to central location and thereby discourage crime against a driver.

In still another embodiment, a viewer of an electronic display of the application may wirelessly connect their personal device to the electronic display for transmitting images and interaction with the electronic display. An example is Apple Airplay in which an i-phone may be used to transmit video or pictures to a TV with Apple AirPlay. Additionally, the electronic display device may then interact via touch screen with the viewer's device.

While primarily being directed to the delivery of information in the form of advertising, the systems and devices of the application may be employed to deliver other content. Such content includes, but is not limited to: books and other documents, entertainment such as streaming video, and the like.

In some embodiments, the invention is a distribution network based on a wireless and/or wired transmission, location tracking systems, mobile, and fixed displays. In these embodiments, a point of sale database and/or customer database are integrated to target content, advertisements, registration, rsvp, and appointments in real time based upon the users encrypted id, gps, interest, and, recent location activity. Thus, advertisements, content, and physical locations are matched to users in their current real time environment.

Used therein, a computer-implemented service matches users to potential content and or services, with the users' location. The system determines this from a user based on interest previously selected by the user, such as shopping preferences, frequented locations, or specific content. The preferences may, for example, be products represented in an encrypted database that correlates with another database where users are identified in various ways.

The system can identify users employing any wireless transmission point or through an encrypted personal identification number. In one embodiment, the service generates the recommended content, location, and content using a previously generated table that maps items to respective lists of “similar” items (i.e. a person had dinner at an American restaurant they might like similar food.

In another example, where a user desires content relating to football while traveling, the system recommends specific sporting events with a bias to football. To generate the suggestions, especially the bias, historical data indicative of users' affinities for particular places, locations, content, and the like is processed periodically to identify correlations with the interests of users.

Content, advertisement, and location data are generated by accessing the user history to identify items similar to those previously selected by the user. In one embodiment, items are recommended based on the users' specific current location, such as a restaurant, spa, golf course, and the like for appointment times.

In another embodiment, the invention is a wireless data network operator configured to receive and/or send data to one or more client devices, and/or supply equipment. The network further may be configured to communicate one of the requests for data to its own or other service that provides request for data by the one or more client devices to the wireless network operator for distribution to the one or more client devices. The wireless network may reference its database for data that is similar, alike, the same, and exact to other integrated databases on its platform. The wireless network may then determine the best way to transmit the data back to the end user for recommendations. The transmission point could include cellular points, gps, satellite, wired transmission, fixed displays, and all other mobile devices.

Another embodiment of the invention would be employed within a structure or complex having multiple retail outlets, such complexes or structures often referred to as a “connected mall.” Portable devices would use “beacon technology” to interact with fixed displays throughout the mall to make custom recommendations to consumers. The connected mall would employ wifi or Bluetooth Beacon technology or any other connectivity systems and protocols known to those of ordinary skill in the art for connectivity.

The system would make shopping recommendations based on a user's preset preferences via the application. The individual retail stores can opt in to the connected network to transmit personalized recommendations based on the notifications the user has set. In one embodiment, the individual retailer would choose proximity points throughout the connected mall to target users as they move throughout the connected mall, displaying the above referenced shopping recommendations and/or other advertising.

In still another embodiment usb device or custom microchip can be employed to establish connectivity with any portable display device and futher make it interactive. Users can opt in to have the system monitor their activities to make content, shopping, and entertainment recommendations. In some embodiments the recommendations would be fully customized to the consumer.

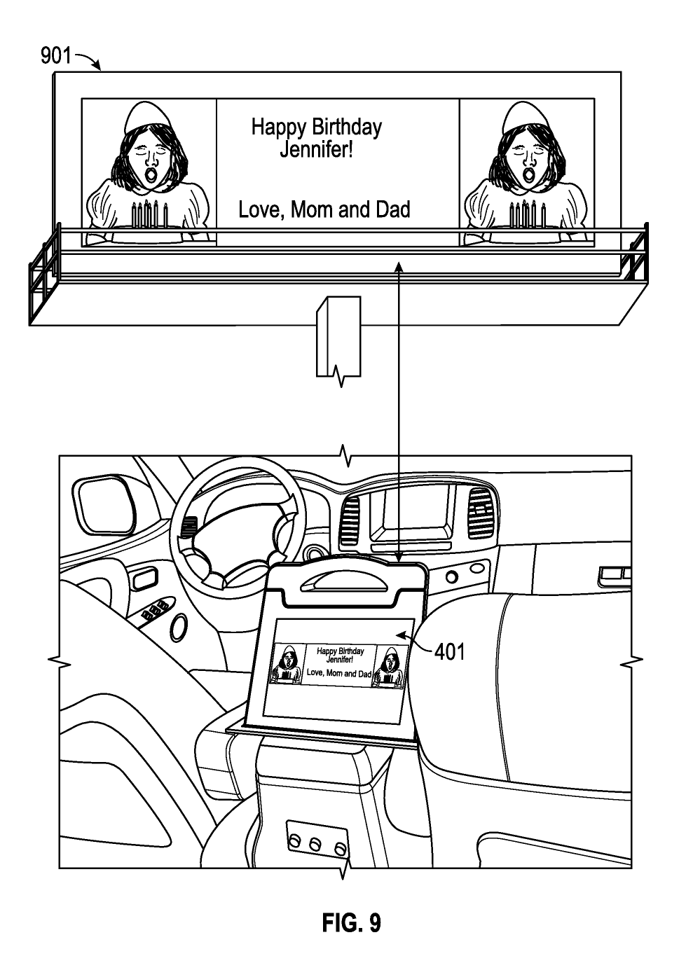

While the term “retailer” has been used to describe those who might employ the methods and systems of the application, the systems and methods of the application may be employed by any kind of merchant as well as those that are attempting to communicate information relating to politics or policy or any other type of non-commercial speech. For example, in addition to merchants selling clothing, the systems and methods of the application may be employed by food sellers (such a Pizzerias), political candidates, and even pollsters. In one embodiment, a user of the system of the application could even purchase advertising such as that illustrated in FIG. 9.

One embodiment of the invention would be one where a system of the application could be used to interact with a vendor that delivers food to select and purchase food and have that food delivered to a gps coordinate. For example, someone in Central Park, New York City, could have pizza delivered to their picnic location. In alternative embodiment such a consumer would be able to interact with a local transporter to purchase food for immediate delivery to their picnic location.

In another embodiment of the invention, a system of the application could be employed to capture audio or video from a fixed display. FIG. 9 illustrates how the content displayed upon a fixed billboard (901) could be captured to a system of the application (401).

In some embodiments the systems of the application are configured to display 3 dimensional images.

The systems and methods of the application may be integrated with extant systems already in place on the internet. For example, in one embodiment, a system of the application may be integrated with a taxi service to recognize when a passenger is being conveyed. In between rides, the subject system may recognize slower or no travel for a while which would indicate an interval between trips. One way in which a system of the application may recognize this would be a new hire would be indicated by a stop followed by a new direction at a faster speed. The system may also take pictures to verify number of hires and length of hire; or require the taxi driver to input number of hires and passengers at the end of drivers work day. This data could be use for both auditing and quality control purposes.

What is claimed is:

1. A system for distributed advertising comprising:
a portable display device, and
a controller,
wherein:
the display device is in communication with the controller,
the display device is portable,
the display device, or an associated device is able to receive and interpret a GPS signal or other signal which can be used to ascertain the location of the display device, and
the display device, or associated device, is configured to display advertising upon command from the controller.

2. The system of claim 1 wherein the display device is a tablet computer.

3. The system of claim 1 wherein the display device is a smart phone.

4. The system of claim 1 wherein the display device communicates with the controller via wifi.

5. The system of claim 1 wherein the display device is transported using a vehicle.

6. The system of claim 1 wherein the display device is transported by a pedestrian.

7. The system of claim 1 wherein the display device additionally comprises a element selected from the group consisting of compass, a motion detector, a camera, sensors to determine the orientation of the display device, and combination thereof.

8. The system of claim 7 wherein the system further comprises a joystick .

9. The system of claim 1 wherein the system further comprises a backpack.

10. The system of claim 9 further comprising straps to secure other system components to the backpack.

11. A method of distributed advertising comprising wirelessly establishing communication between a portable display device and a controller wherein:
the display device or an associated device senses its location and uploads that information to the controller; and
the controller, based upon the location of the display device, transmits to the display device advertising content.

12. The method of claim 11 wherein advertisers may select a size of a geographic area in which the advertising content is displayed.

13. The method of claim 11 wherein transporters of portable displays are rewarded for effective advertising.

14. The method of claim 11 wherein settings on the portable display device are adjusted based upon environmental conditions.

15. The method of claim 11 wherein transporters of the portable devices are paid a fee.

16. The method of claim 15 wherein the size of the fee is determined based upon a condition selected from the group consisting of: proximity of the transporter to a retail establishment, proximity of the transporter to an event, size of display used by the transporter, number of transporters in a area, and combinations thereof.

17. The method of claim 11 wherein more than one transporter is employed to display a single advertisement.

18. The method of claim 11 wherein the portable display device can accept input from consumers.
